(19) United States
(12) Patent Application Publication
(10) Pub. No.: US 2003/0113630 A1
(43) Pub. Date: Jun. 19, 2003

(54) Anodic zinc electrode for use in an alkaline based electrochemical cell

(76) Inventors: Ramesh C. Kainthla, College Station, TX (US); David J. Manko, Bryan, TX (US)

Correspondence Address: FACTOR & PARTNERS, LLC, 1327 W. WASHINGTON BLVD., SUITE 5G/H, CHICAGO, IL, 60607, US

(21) Appl. No.: 10/006,793

(22) Filed: Dec. 6, 2001

(51) Int. Cl. H01M 4/42; H01M 4/62; H01M 4/54; H01M 4/52

(52) U.S. Cl. 429/231; 429/229; 429/217; 429/59; 429/219; 429/223

(57) ABSTRACT

An anodic zinc electrode for use in an electrochemical cell comprising: a current collector; and an active material composition applied to the current collector, wherein the active material composition includes Zn and ZnO, and wherein the weight ratio of the Zn to ZnO ranges from approximately 1-2 to approximately 1 which enables the anodic zinc electrode to be associated with an electrochemical cell assembled in a charged or discharged state.

### BACKGROUND OF THE INVENTION

1. Field of the Invention

The present invention relates in general to electrochemical cells, and more particularly, to an anodic zinc electrode for use in an alkaline based electrochemical cell which is compositionally configured for assembly in a charged or discharged state.

2. Background Art

Electrochemical cells having zinc based anodic electrodes have been known in the art for years, and include, for example, nickel/zinc, silver/zinc, zinc/air and manganese dioxide/zinc type electrochemical cells. The above-identified electrochemical cells having zinc based anodic electrodes are of significant commercial interest due to, among other things: (1) the abundance, and, therefore, low cost of zinc; (2) the low equivalent weight of zinc based anodic electrodes; (3) the high coulombic efficiency of electrochemical cells having zinc based anodic electrodes; (4) the reversible or secondary electrochemical behavior of electrochemical cells having zinc based anodic electrodes; and (5) the reduced environmental disposal issues associated with electrochemical cells having zinc based anodic electrodes—compared to, for example, electrodes based upon more toxic metals, such as lead or cadmium.

Of the above-identified electrochemical cells, to the best of Applicant's knowledge, manganese-dioxide/zinc electrochemical cells have been assembled exclusively in charged state. These cells have been made in the bobbin configuration with zinc gel as the negative electrode and are disclosed in U.S. Pat. No. 5,721,068. Zinc/air electrochemical cells have also been assembled in the charged state and use metallic zinc as the anodic electrode. Silver/zinc electrochemical cells have been assembled in the charged state as well as in the discharged state. These cells use different compositional configurations of the electrodes, but, to the best of Applicant's knowledge, a single compositional configuration of the anode (Zinc electrode) has not been disclosed which enables a silver/zinc electrochemical cell to be assembled in both the charged or and discharged state. Nickel/zinc electrochemical cells have traditionally been assembled in the discharged state, except for zinc gel bobbin configurations which are assembled in the charged state.

If an electrochemical cell having a zinc based electrode is assembled in the charged state, for example silver/zinc and zinc/air electrochemical cells, the zinc based electrode is made using zinc oxide which is first charged separately in an alkaline bath, washed, and finally re-pressed. The fabrication of these types of electrochemical cells requires the extra, processing steps, thereby leading to material increases in the time of assembly and also manufacturing cost. It would, therefore, be advantageous to provide an electrode which is already charged and does not need additional processing before being assembled in an electrochemical cell.

Many inventors have reported different compositions for zinc electrodes. The compositions typically have zinc oxide as the major component, a metal oxide, such as lead oxide, cadmium oxide, or bismuth oxide as hydrogen suppressant, and a binder, such as polystyrene, methyl cellulose, polytetrafluoroethylene (hereinafter “PTFE”), polyvinylalcohol (hereinafter “PVA”), cellulose, etcetera.

Adler et al. [T. C. Adler, F. R. McLarnon and E. J. Cairns, Journal of the Electrochemical Society, Vol. 140, p. 289 (February 1993)] describe an electrode containing 93% zinc oxide, 2% lead oxide, 1% newsprint, and 4% PTFE as binder. To reduce the solubility of zincate, additional oxides/hydroxide have also been added. U.S. Pat. No. 4,358,517 discloses a zinc electrode containing 0.25 to about 1.5 moles of calcium hydroxide per mole of zinc oxide (active ingredient), lead oxide (hydrogen suppressant) content up to about 4% by weight of the mixture, and cellulose (as binder) of about 0.5% to about 10% by weight of the mixture.

U.S. Pat. No. 5,460,899 describes a zinc electrode with 5-20% of metal (Pb, Bi, Cd, Ga or Tl) oxide, 15-40% calcium hydroxide, 5% PTFE as binder and the remainder zinc oxide as the active component.

U.S. Pat. No. 5,773,176 discloses an electrode containing bismuth oxide and other additives including lead oxide and/or cadmium oxide with zinc oxide. The mixture was wet pasted to form a strip and then cut to size for fabricating the zinc oxide electrodes.

In addition, zinc oxide has far lower conductivity than zinc metal. As such, electrodes made with zinc oxide need to be charged slowly to convert the oxide to the metal. It would be advantageous to be able to charge and discharge the zinc based anodic electrodes at high rates.

Moreover, zinc electrodes prepared from zinc oxide are typically laminated on to a copper current collector. When such an electrode comes in contact with an alkaline electrolyte, because of the potential of the zinc oxide, the copper surface can become oxidized, leading to a significantly high resistance. This type of electrode thus needs to be charged immediately and slowly. If the cell isn't charged for a long time corrosion of copper can take place, deteriorating the performance of the cell. To avoid the corrosion of the copper surface, the current collector is typically electroplated with silver, lead, tin, or bismuth. Such electroplating is an undesirable, extra step which again increases the cost of the current collector and hence that of the electrochemical cell. It would thus be advantageous to use a copper current collector without any additional surface coating and be able to protect the surface even if the cell isn't charged for a long time.

These and other objectives of the invention will become apparent in light of the present specification, claims, and drawings.

### SUMMARY OF THE INVENTION

The present invention is directed to an anodic zinc electrode for use in an alkaline based electrochemical cell comprising: (a) a current collector; and (b) an active material composition applied to the current collector, wherein the active material composition includes Zn and ZnO, and wherein the weight ratio of the Zn to ZnO ranges from approximately 1-2 to approximately 1, and more preferably from approximately 1.5-2 to approximately 1 which enables the anodic zinc electrode to be associated with an electrochemical cell assembled in a charged or discharged state.

In a preferred embodiment of the present invention, the anodic zinc electrode further comprises a zincate solubility modifier selected from the group consisting of Be(OH)₂, Mg(OH)₂, Ca(OH)₂, Sr(OH)₂, Ba(OH)₂, Ra(OH)₂, and mixtures thereof.

In another preferred embodiment of the present invention, the anodic zinc electrode further comprises a hydrogen gas suppressant selected from the group consisting of PbO, CdO, Bi₂O₃, In₂O₃, and mixtures thereof.

In yet another preferred embodiment of the present invention, the anodic zinc electrode further comprises a binding agent selected from the group consisting of CMC, PTFE, PVA, and mixtures thereof.

The present invention is also directed to an electrochemical cell comprising: (a) a cathodic electrode; (b) an alkaline electrolyte; (c) separator; and (d e) an anodic zinc electrode comprising: (1) a current collector; and (2) an active material composition applied to the current collector, wherein the active material composition includes Zn and ZnO, and wherein the weight ratio of the Zn to ZnO ranges from approximately 1-2 to approximately 1, and more preferably from approximately 1.5-2 to approximately 1 which enables the anodic zinc electrode to be associated with an electrochemical cell assembled in a charged or discharged state.

In accordance with the present invention a method for manufacturing an anodic zinc electrode for use in an alkaline based electrochemical cell is disclosed which comprises the steps of: (a) providing a current collector; (b) providing an active material composition, wherein the active material composition includes Zn and ZnO, and wherein the weight ratio of the Zn to ZnO ranges from approximately 1-2 to approximately 1, and more preferably from approximately 1.5-2 to approximately 1 which enables the anodic zinc electrode to be associated with an electrochemical cell assembled in a charged or discharged state; and (c) associating the active material composition with the current collector.

### BRIEF DESCRIPTION OF THE DRAWINGS

The invention will now be described with reference to the drawings wherein:

FIG. 1 of the drawings is a schematic representation of an alkaline based electrochemical cell fabricated in accordance with the present invention;

FIG. 2 of the drawings is a two-dimensional plot showing change in discharge capacity as a function of cycle number for Experiment No. 1;

FIG. 3 of the drawings is a two-dimensional plot showing change in discharge capacity as a function of cycle number for Experiment No. 2;

FIG. 4 of the drawings is a two-dimensional plot showing change in discharge capacity as a function of cycle number for Experiment No. 3; and

FIG. 5 of the drawings is a two-dimensional plot showing change in discharge capacity as a function of cycle number for Experiment No. 4.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

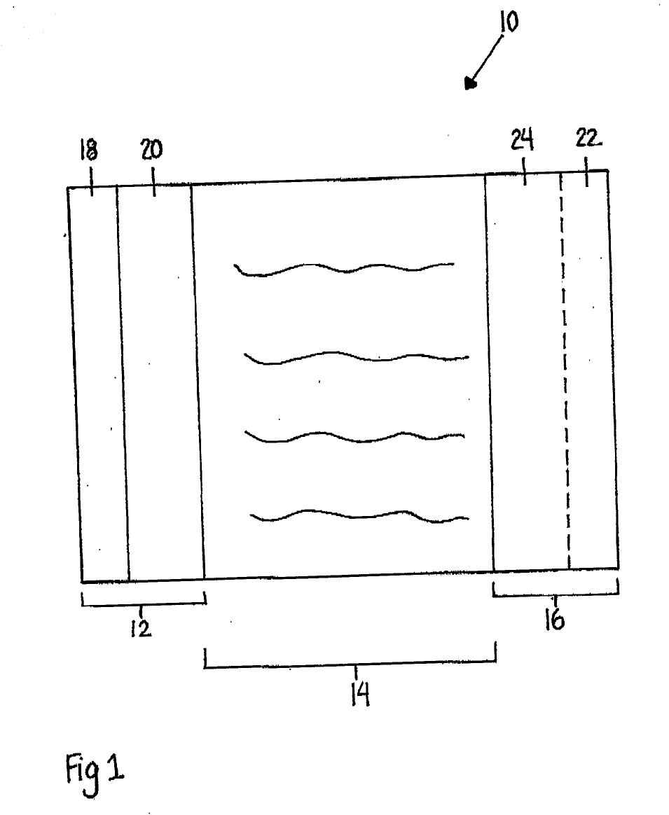

Referring now to the drawings, and to FIG. 1 in particular, a schematic representation of a first embodiment of electrochemical cell 10 is shown as generally comprising: zinc based anodic electrode 12, separated by a separator/absorber containing electrolyte 14, from cathodic electrode 16. It will be understood that FIG. 1 is merely a schematic representation of electrochemical cell 10. As such, some of the components may be distorted from their actual scale for pictorial clarity. As will be explained in greater detail below, zinc based anodic electrode 12 is compositionally configured for assembly in a cell assembled in charged or discharged state.

Zinc based anodic electrode 12 includes current collector 18 and active material 20. For purposes of the present disclosure, current collector 20 is fabricated from copper. It will be understood, however, that current collector 20 may be fabricated from any one of a number of other conductive materials known to those with ordinary skill in the art having the present disclosure before them. Current collector 20 may comprise perforated metal, non-perforated metal, mesh, expanded metal, and combinations thereof.

Active material 20 includes zinc powder (Zn) and zinc oxide powder (ZnO) which are present in weight ratios which enable assembly of the cells in a charged or discharged state, and include 1-2:1 Zn to ZnO, and more preferably 1.5-2:1 Zn to ZnO. It has been experimentally concluded that for compositions outside of the above-identified ranges, the electrode can only be used with only one type of cell. Thus, for Zn/ZnO ratios>2, the electrode is suitable for use in cells assembled in charged state only, and for ratios<1 the electrode is suitable for use in cells assembled in discharge state only.

Active material 20 may also include zincate solubility modifiers such as Be(OH)₂, Mg(OH)₂, Ca(OH)₂, Sr(OH)₂, Ba(OH)₂, Ra(OH)₂, and mixtures thereof.

In accordance with the present invention active material 20 may also include binding agents or binders such as carboxy-methyl cellulose (hereinafter “CMC”), poly-tetra fluoro ethylene (hereinafter “PTFE”), poly vinyl alcohol (hereinafter “PVA”), and mixtures thereof.

Active material 20 may further include a hydrogen gas suppressant, such as, for example, PbO, CdO, Bi₂O₃, In₂O₃, and mixtures thereof.

Electrolyte 14 is preferably an aqueous solution of KOH, LiOH, and/or NaOH.

Cathodic electrode 16 may be fabricated from a conventional cathodic electrode material, such as sintered nickel, or, alternatively may be fabricated from a conventional cathodic current collector including nickel foam 22 and active material 24, such as a conventional manganese dioxide, Nickel-hydroxide and silver-oxide paste compositions. While specific examples of cathodic electrode materials have been disclosed, it will be understood that numerous other cathodic electrode materials are likewise suitable for use in accordance with the present invention.

### Anodic Zinc Electrode Manufacture

Zinc electrodes made in accordance with the present invention are preferably made from zinc powder (Zn), zinc oxide powder (ZnO), calcium hydroxide Ca(OH)₂, CMC, PbO, and PTFE. Specifically, the electrodes may be made by dry mixing the Zn, ZnO (ratio of the weights of Zn to ZnO being between 1-2:1), Ca(OH)₂, CMC and PbO. The mixture may then be blended with an organic lubricant in a blender. PTFE may then be added to the blend which may be further blended. The blend may then be filtered to remove any extra organic lubricant, and to obtain a wet cake with all the ingredients. The cake may next be passed through a set of rotating rollers with a wide gap. The material is passed until it starts to come together and forms a continuous thick sheet. Next, the distance between the gaps is reduced in multiple steps to the desired thickness with material passed through at each gap to reduce the thickness of the sheet. Once a sheet of desired thickness is formed, it is air dried and ready to be cut into proper size pieces. The appropriate size pieces are cut using cutting dies. To make a full electrode two pieces (one on each side) are laminated to a copper current collector with a lead attached to it, and to make a half electrode only one piece is attached to one side only.

The pieces can be attached to the current collector using pressing die in a press or by passing them through a set of rotating rollers with a desired gap. The current collector can be a copper mesh, expanded, perforated or pierced sheet. The lead can be a wire or set of copper wires, or copper tabs. The electrodes made as described are suitable for use in cells assembled in charged or discharged state.

In support of the present invention, the following experiments were conducted:

### Experiment No. 1

104 grams (hereinafter “g”) of zinc powder (52 g fine Zn+52 g coarse Zn), 52 g of zinc oxide (Zn/ZnO weight ratio equal to 2:1), 24 g of Ca(OH)₂, 2 g of CMC and 8 g of PbO were dry mixed. The mixture was added to 700 milliliters (hereinafter “ml”) of organic lubricant in a blender and blended for 1 minute. 10 g of PTFE powder was added to the blender and the mixture was blended for an additional minute. The blend was vacuum filtered so that the weight of the filtered cake was 260 g. The cake was passed through a set of rotating rollers with a gap of 6.35 millimeters (hereinafter “mm”), until the material started to form a continuous sheet. The gap between the roller was slowly reduced to 0.635 mm. With this gap the thickness of the sheet was 0.80 mm. Next the sheet was air-dried. The sheet did not tear easily and could be dropped to the floor without any visible damage showing its superior physical integrity.

60 mm×60 mm copper mesh current collectors with a thickness of 0.39 mm were cut into 41.275 mm×38.1 mm pieces. A copper wire of 0.5 mm diameter was spot welded on to the current collector. 41.275 mm×38.1 mm pieces were cut from the sheet of material using dies. To make full electrodes two pieces of the material were pressed on to the current collector using pressing dies, at 25,000 pounds per square inch (hereinafter “psi”) for 2 minutes. Aldex paper was placed between the material and the die to prevent the material from sticking to the die. To make a half electrode, only one piece was attached to the current collector at the same pressure and for the same time. Part of the material becomes embedded in to the open spaces of the mesh leading to a very good adhesion of the material to the mesh. The final thickness of the full electrode was 1.10 mm while that of the half electrode was 0.66 mm. The electrodes were used in Ni—Zn storage cell assembled in discharged state.

Sintered nickel electrodes were cut in to 41.275 mm×38.1 mm pieces. A nickel wire of 0.5 mm diameter was spot welded on to one corner of the electrode. The electrodes were wrapped in one Freudenberg absorber FS2119 and heat sealed in one layer of SciMat 31/08 separator with the top open. One full and two half Zn electrodes as prepared above were also wrapped in one layer each of Freudenberg absorber FS2119 and heat sealed in one layer of SciMat 31/08 separator with top open. Two nickel electrodes, one full and two half Zn electrodes were assembled in a polysulfone case with the symmetrical configuration: 1/2Zn Ni Zn Ni 1/2Zn. The cell was filled with an electrolyte containing 20% KOH+1% LiOH. The expected capacity of the cell was 0.9 Ah.

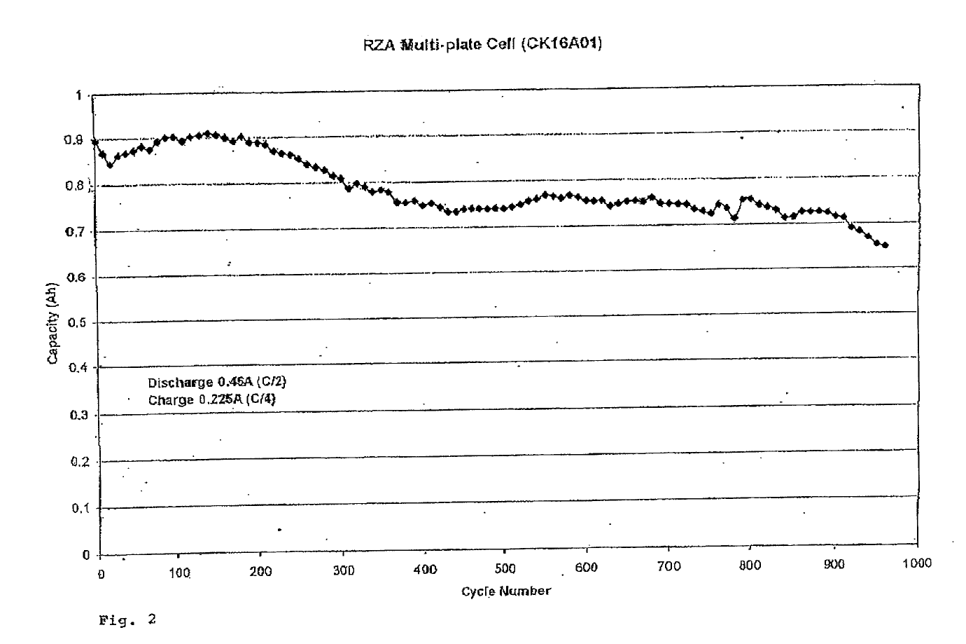

The cell was charged at constant current of 0.225A (C/4 rate) to 2.0 volts (hereinafter “V”) followed by constant voltage charge at 2.0V until the current dropped to 0.075A. It was discharged at 0.45A (C/2 rate) to 1.4V. FIG. 2 shows the capacity as a function of cycle number. The cell had excellent rechargeability with 900 cycles obtained before the capacity dropped below 80% of the expected capacity.

### Experiment No. 2

535 g of zinc powder (coarse zinc), 270 g of zinc oxide (Zn/ZnO oxide weight ratio equal to 1.98:1), 120 g of Ca(OH)₂, 10 g of CMC and 40 g of PbO were dry mixed. The mixture was added to 3,500 ml of organic lubricant in a blender and blended for 1 minute. 25 g of PTFE powder was added to the blender and the mixture blended for another minute. The blend was vacuum filtered so that the weight of the filtered cake was 1,300 g. The cake was passed through a set of rotating rollers with a gap of 6.35 mm, until the material started to form a continuous sheet. The gap between the roller was slowly reduced to obtain sheet thickness of 0.45 mm. The sheet was air-dried. The sheet did not tear easily and could be dropped to the floor without any visible damage showing its superior physical integrity.

30 mm×30 mm copper mesh current collectors with a thickness of 0.39 mm were cut into 73.025 mm×48.25 mm pieces. A copper tab of 0.5 mm thickness was spot welded on to the current collector. 73.025 mm×48.25 mm pieces were cut from the sheet of material using dies. To make full electrodes two pieces of the material were pressed on to the current collector using pressing dies, at 25,000 psi for 2 minutes. Aldex paper was placed between the material and the die to prevent the material from sticking to the die. To make a half electrode, only one piece was attached to the current collector at the same pressure and for the same time. Part of the material becomes embedded in to the open spaces of the mesh leading to a very good adhesion of the material to the mesh. The final thickness of the fill electrode was 0.73 mm while that of the half electrode was 0.48 mm. The electrodes were used in a Ni—Zn storage cell assembled in discharged state.

Sintered nickel electrodes were cut in to 73.025 mm×48.25 mm pieces. A nickel tab of 0.5 mm thickness was spot welded on to one corner of the electrode. The electrodes were wrapped in one Freudenberg absorber FS2119 and heat sealed in three layers of SciMat 31/08 separator with top open. Zinc electrodes as prepared above were also wrapped in one layer each of Freudenberg absorber FS2119. Five nickel electrodes, four full and two half zinc electrodes were assembled in a polysulfone case with the symmetrical configuration: 1/2 Zn Ni Zn Ni Zn Ni Zn Ni Zn Ni 1/2Zn. The cell was filled with an electrolyte containing 20% KOH+1% LiOH. The expected capacity of the cell was 5.0 Ah.

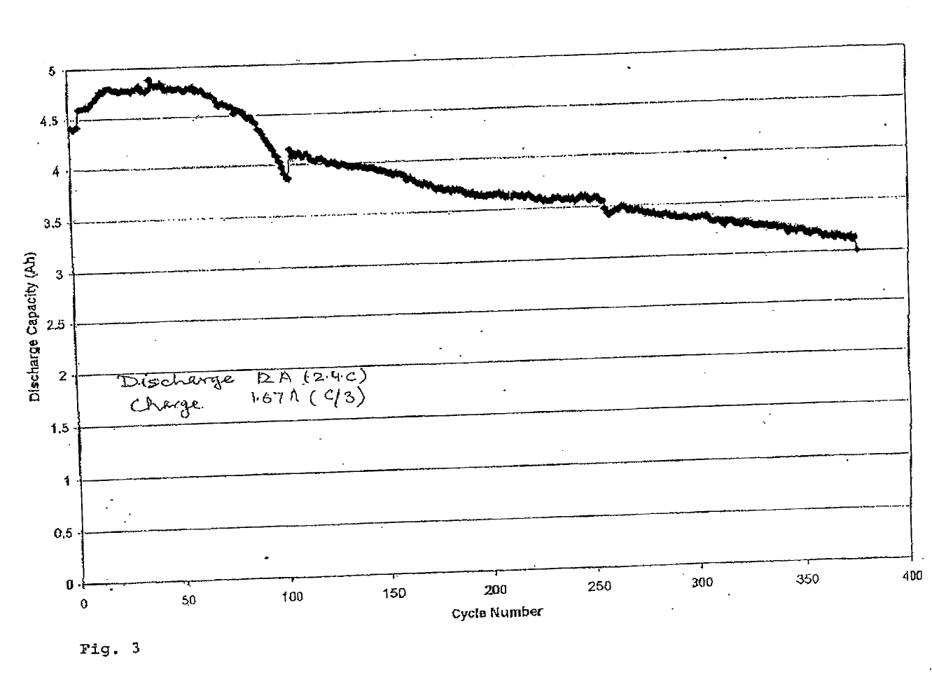

The cell was charged at constant current of 1.67A (C/3 rate) to 2.03V followed by constant voltage charge at 2.03V until the current dropped to 0.555A. It was discharged at 12A (2.4C rate) to 1.0V. FIG. 3 shows the capacity as a function of cycle number. The cell had excellent rechargeability with 375 cycles obtained before the capacity dropped below 60% of the expected capacity.

### Experiment No. 3

805 g of zinc oxide (Zn/ZnO weight ratio equal to 0:1), 120 g of Ca(OH)₂, 10 g of CMC and 40 g of PbO were dry mixed. The mixture was added to 3,500 ml of organic lubricant in a blender and blended for 1 minute. 25 g of PTFE powder was added to the blender and the mixture blended for another minute. The blend was vacuum filtered so that the weight of the filtered cake was 1,300 g. The cake was passed through a set of rotating rollers with a gap of 6.35 mm, untill the material started to form a continuous sheet. The gap between the roller was slowly reduced to get sheet thickness of the 0.68 mm. The sheet/s was air dried. The sheet was very fragile and tended to tear easily.

30 mm×30 mm copper mesh current collectors with a thickness of 0.39 mm were cut into 41.275 mm×38.1 mm pieces. A copper wire of 0.5 mm diameter was spot welded on to the current collector. 41.275 mm×38.1 mm pieces were cut from the sheet of material using dies. To make full electrodes two pieces of the material were pressed on to the current collector using pressing dies, at 25,000 psi for 2 minutes. Aldex paper was placed between the material and the die to prevent the material from sticking to the die. To make a half electrode, only one piece was attached to the current collector at the same pressure and for same time. Part of the material becomes embedded in to the open spaces of the mesh leading to a very good adhesion of the material to the mesh. The final thickness of the full electrode was 0.81 mm while that of the half electrode was 0.48 mm. The electrodes were used in a Ni—Zn storage cell assembled in discharged state.

Sintered Nickel electrodes were cut in to 41.275 mm×38.1 mm pieces. A Nickel wire of 0.5 mm diameter was spot welded on to one corner of the electrode. The electrodes were wrapped in one Freudenberg absorber FS2119 and heat sealed in one layer of SciMat 31/08 separator with the top open. One full and two half zinc electrodes as prepared above were also wrapped in one layer each of Freudenberg absorber FS2119 and heat sealed in one layer of SciMat 31/08 separator with top open. Two nickel electrodes, one full and two half zinc electrodes were assembled in a polysulfone case with the symmetrical configuration: 1/2Zn Ni Zn Ni 1/2Zn. The cell was filled with an electrolyte containing 20% KOH+1% LiOH. The expected capacity of the cell was 0.9 Ah.

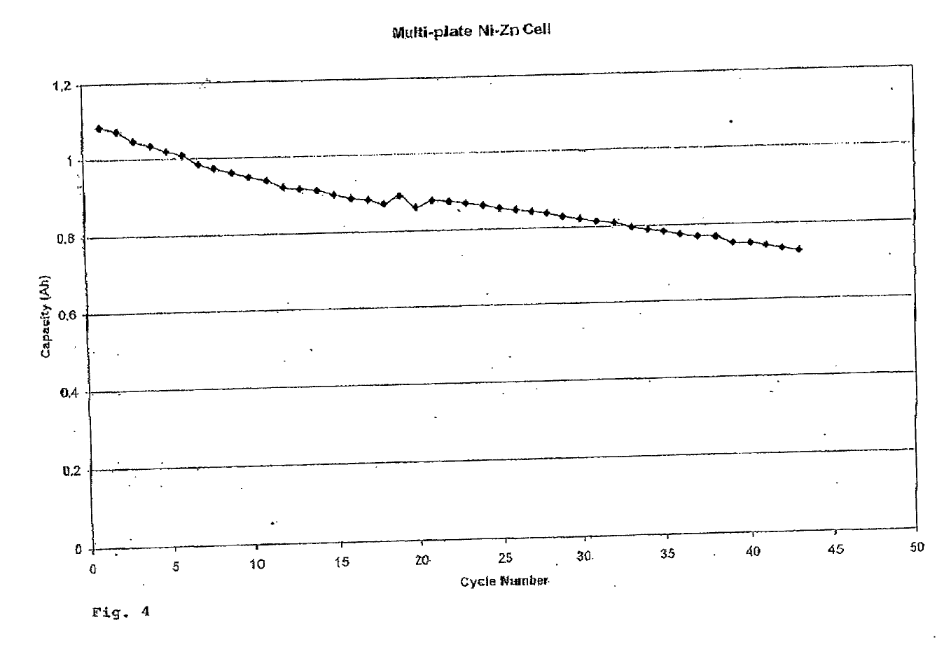

The cell was charged at constant current of 0.225A (C/4 rate) to 2.0V followed by constant voltage charge at 2.0V till the current dropped to 0.075A. It was discharged at 0.45A (C/2 rate) to 1.4V. FIG. 4 shows the capacity as a function of cycle number. The cell did not cycle as well as the cell in Example 1, with ˜40 cycles obtained before the capacity dropped below 80% of the expected capacity.

### Experiment No. 4

104 g of Zn powder (52 g fine+52 g coarse zinc), 52 g of ZnO (Zn/ZnO weight ratio equal to 2:1), 24 g of Ca(OH)₂, 4 g of CMC and 6 g of PbO were dry mixed. The mixture was added to 700 ml of organic lubricant in a blender and blended for 1 minute. 10 g of PTFE powder was added to the blender and the mixture blended for another minute. The blend was vacuum filtered so that the weight of the filtered cake was 260 g. The cake was passed through a set of rotating rollers with a gap of 6.35 mm, until the material started to form a continuous sheet. The gap between the roller was slowly reduced to get sheet thickness of 1.2 mm. The sheet was air dried. The sheet did not tear easily and could be dropped to the floor without any visible damage showing its superior physical integrity.

30 mm×30 mm copper mesh current collectors with a thickness of 0.39 mm were cut into 41.275 mm×38.1 mm pieces. A copper wire of 0.5 mm diameter was spot welded on to the current collector. 41.275 mm×38.1 mm pieces were cut from the sheet of material using dies. To make full electrodes two pieces of the material were pressed on to the current collector using pressing dies, at 25,000 psi for 2 minutes. Aldex paper was placed between the material and the die to prevent the material from sticking to the die. To make a half electrode, only one piece was attached to the current collector at the same pressure and for same time. Part of the material becomes embedded in to the open spaces of the mesh leading to a very good adhesion of the material to the mesh. The final thickness of the full electrode was 1.42 mm while that of the half electrode was 0.85 mm. The electrodes were used in a MnO₂—Zn storage cell assembled in charged state.

A cathode mix was made by mixing rechargeable Mn-dioxide, prepared by the procedure described in U.S. Pat. No. 5,419,986, graphite and PVDF binder. Rechargeable Mn-dioxide (hereinafter “RMD”) electrode was made by pressing the cathode mix on to 41.275 mm×38.1 mm nickel foam. A nickel wire of 0.5 mm diameter was spot welded on to one corner of the electrode. The electrodes were wrapped in one Freudenberg absorber FS2119 and heat sealed in two layers of SPPO coated SciMat 31/08 separator with top open. One full and two half zinc electrodes as prepared above were also wrapped in one layer each of Freudenberg absorber FS2119 and heat sealed in two layers of SciMat 31/08 separator with top open. Two rechargeable Mn-dioxide electrodes, one full and two half zinc electrodes were assembled in a polysulfone case with the symmetrical configuration: 1/2Zn RMD Zn RMD 1/2Zn. The cell was filled with an electrolyte containing 20% KOH+1% LiOH. The expected capacity of the cell was 1.4 Ah.

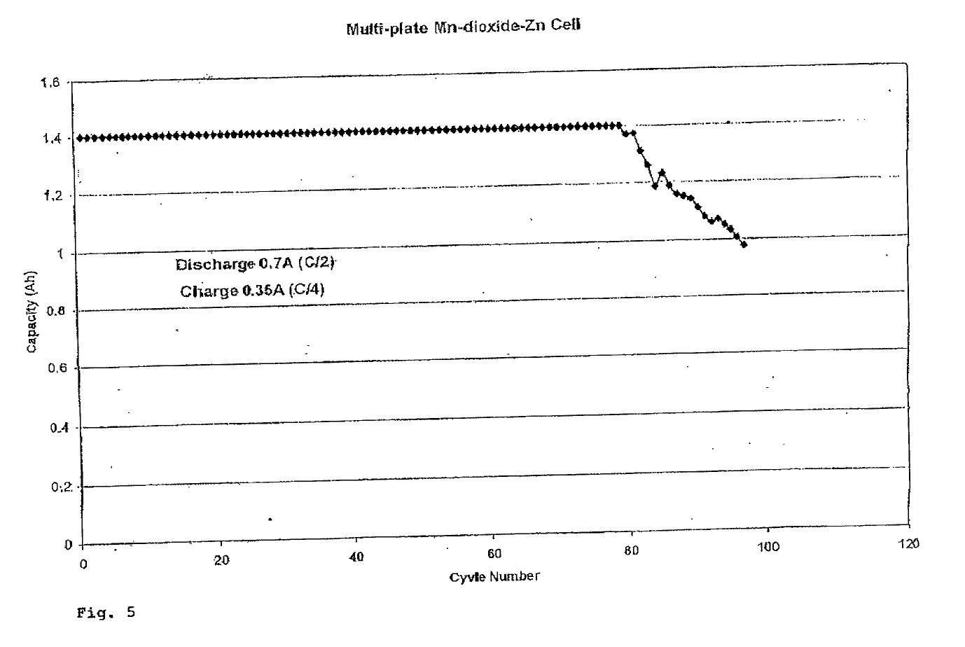

The cell was discharged at constant current of 0.7A (C/2 rate) for 2 hrs or 0.5V, whichever came first. It was charged at 0.35A (C/4 rate) for 4 hrs. 10 minutes or 2.0V. The cycling was stopped when the discharged capacity went below 0.98A (i.e. 70% of the rated capacity). The cycle life was calculated for discharge capacity>80% (1.12A) of the rated capacity. FIG. 5 shows the capacity as a function of cycle number. The cell cycled to 89 cycles before the capacity dropped below the 80% level.

### Experiment No. 5

Zinc sheets were prepared using the procedure given above and different types of metallic zinc and without any zinc. 41.275 mm×38.1 mm pieces were cut from these sheets using dies and pressed at 25,000 psi for 2 minutes without any current collector.

The pieces were weighed and their thicknesses measured. Table 1 shows the density and capacity/weight of the different types of electrodes.

| | | Binder | | |
|---|---|---|---|---|
| | | Concentration | Density | Capacity |
| Example | Zn type | % | (g/cm³) | (Ah/g) |
| A | Zn (fine mesh) | 2.5 | 1.68 | 0.616 |
| B | Zn (50/50 blend of | 2.5 | 2.15 | 0.616 |
| | fine and | | | |
| | coarse mesh) | | | |
| C | Zn (coarse mesh) | 2.5 | 2.26 | 0.616 |
| D | No Zn | 2.5 | 1.12 | 0.531 |

Weight ratio of Zn/ZnO = 2:1 for A, B & C and 0:1 for D

The electrodes with metallic zinc have higher density as well as capacity, which helps in increasing the energy density of the cells and batteries using these electrodes.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. An anodic zinc electrode for use in an alkaline based electrochemical cell, comprising:
a current collector; and
an active material composition applied to the current collector, wherein the active material composition includes Zn and ZnO, and wherein the weight ratio of the Zn to ZnO ranges from approximately 1-2 to approximately 1 which enables the anodic zinc electrode to be associated with an electrochemical cell assembled in a charged or discharged state.

2. The anodic zinc electrode according to claim 1, further comprising a zincate solubility modifier selected from the group consisting of Be(OH)₂, Mg(OH)₂, Ca(OH)₂, Sr(OH)₂, Ba(OH)₂, Ra(OH)₂, and mixtures thereof.

3. The anodic zinc electrode according to claim 1, further comprising a hydrogen gas suppressant selected from the group consisting of PbO, CdO, Bi₂O₃, In₂O₃, and mixtures thereof.

4. The anodic zinc electrode according to claim 1, further comprising a binding agent selected from the group consisting of CMC, PTFE, PVA, and mixtures thereof.

5. The anodic zinc electrode according to claim 1, wherein the weight ratio of the Zn to ZnO ranges from approximately 1.5-2:1.

6. The anodic zinc electrode according to claim 5, further comprising a zincate solubility modifier selected from the group consisting of Be(OH)₂, Mg(OH)₂, Ca(OH)₂, Sr(OH)₂, Ba(OH)₂, Ra(OH)₂, and mixtures thereof.

7. The anodic zinc electrode according to claim 5, further comprising a hydrogen gas suppressant selected from the group consisting of PbO, CdO, Bi₂O₃, In₂O₃, and mixtures thereof.

8. The anodic zinc electrode according to claim 5, further comprising a binding agent selected from the group consisting of CMC, PTFE, PVA, and mixtures thereof.

9. An electrochemical cell, comprising:
a cathodic electrode;
a separator/absorber;
an alkaline electrolyte; and
an anodic zinc electrode comprising:
a current collector; and
an active material composition applied to the current collector, wherein the active material composition includes Zn and ZnO, and wherein the weight ratio of the Zn to ZnO ranges from approximately 1-2 to approximately 1 which enables the anodic zinc electrode to be associated with an electrochemical cell assembled in a charged or discharged state.

10. The electrochemical cell according to claim 9, wherein the anodic zinc electrode further comprises a zincate solubility modifier selected from the group consisting of Be(OH)₂, Mg(OH)₂, Ca(OH)₂, Sr(OH)₂, Ba(OH)₂, Ra(OH)₂, and mixtures thereof.

11. The electrochemical cell according to claim 9, wherein the anodic zinc electrode further comprises a hydrogen gas suppressant selected from the group consisting of PbO, CdO, Bi₂O₃, In₂O₃, and mixtures thereof.

12. The electrochemical cell according to claim 9, wherein the anodic zinc electrode further comprises a binding agent selected from the group consisting of CMC, PTFE, PVA, and mixtures thereof.

13. The electrochemical cell according to claim 9, wherein the cathodic electrode comprises manganese dioxide.

14. The electrochemical cell according to claim 9, wherein the cathodic electrode comprises nickel-hydroxide and/or nickel-oxide.

15. The electrochemical cell according to claim 9, wherein the cathodic electrode comprises silver and/or silver-oxide.

16. The electrochemical cell according to claim 9, wherein the weight ratio of the Zn to ZnO ranges from approximately 1.5-2:1.

17. The electrochemical cell according to claim 16, wherein the anodic zinc electrode further comprises a zincate solubility modifier selected from the group consisting of Be(OH)₂, Mg(OH)₂, Ca(OH)₂, Sr(OH)₂, Ba(OH)₂, Ra(OH)₂, and mixtures thereof.

18. The electrochemical cell according to claim 16, wherein the anodic zinc electrode further comprises a hydrogen gas suppressant selected from the group consisting of PbO, CdO, Bi₂O₃, In₂O₃, and mixtures thereof.

19. The electrochemical cell according to claim 16, wherein the anodic zinc electrode further comprises a binding agent selected from the group consisting of CMC, PTFE, PVA, and mixtures thereof.

20. The electrochemical cell according to claim 16, wherein the cathodic electrode comprises manganese dioxide.

21. The electrochemical cell according to claim 16, wherein the cathodic electrode comprises nickel-hydroxide and/or nickel-oxide.

22. The electrochemical cell according to claim 16, wherein the cathodic electrode comprises silver and/or silver-oxide.

24. A method for manufacturing an anodic zinc electrode for use in an alkaline based electrochemical cell, comprising the steps of:
providing a current collector;
providing an active material composition, wherein the active material composition includes Zn and ZnO, and wherein the weight ratio of the Zn to ZnO ranges from approximately 1-2 to approximately 1 which enables the anodic zinc electrode to be associated with an electrochemical cell assembled in a charged or discharged state; and
associating the active material composition with the current collector.

25. A method for manufacturing an anodic zinc electrode for use in an alkaline based electrochemical cell, comprising the steps of:
providing a current collector;
providing an active material composition, wherein the active material composition includes Zn and ZnO, and wherein the weight ratio of the Zn to ZnO ranges from approximately 1.5-2 to approximately 1 which enables the anodic zinc electrode to be associated with an electrochemical cell assembled in a charged or discharged state; and
associating the active material composition with the current collector.
